(19) United States
(12) Patent Application Publication
(10) Pub. No.: US 2016/0125092 A1
(43) Pub. Date: May 5, 2016

(54) WEB COMPONENT DISPLAY BY CROSS DEVICE PORTAL

(71) Applicant: International Business Machines Corporation, Armonk, NY (US)

(72) Inventors: Jaspreet Singh, Delhi (IN); Thomas Stober, Boeblingen (DE)

(21) Appl. No.: 14/698,950

(22) Filed: Apr. 29, 2015

Related U.S. Application Data
(63) Continuation of application No. 14/531,361, filed on Nov. 3, 2014.

(51) Int. Cl. G06F 17/30; H04L 29/08

(52) U.S. Cl. CPC G06F 17/30896; G06F 17/30893; H04L 67/02

(57) ABSTRACT

In an approach to distributing web components for display, a computer receives a request for a plurality of web components from a user on a first computing device. The computer fetches the web components. The computer determines whether the first computing device and one or more additional computing devices are registered in association with the user. Responsive to determining the first computing device and one or more additional computing devices are registered in association with the user, the computer identifies preferred device capabilities for at least one of the web components. The computer identifies a best match of the preferred device capabilities for the at least one of the web components to one or more device capabilities of a target computing device. The computer distributes the at least one of the web components to the first computing device or the one or more additional computing devices.

### BACKGROUND OF THE INVENTION

The present invention relates generally to the field of data transfer, and more particularly to distributing web components for display across multiple computing devices.

A web portal is a single web page that brings together, or aggregates, content from a number of other systems or servers. Often, each information source gets a dedicated area on the page for displaying information, sometimes referred to as a portlet. An application server performs most of the crucial functions of an application. For portals that present application functionality to a user, a portal server acts as a front piece of a server configuration that includes some connectivity to the application server. The server hosting the portal may only be a “pass through” for the user. By use of portlets, application functionality can be presented in any number of portal pages. Portlets are pluggable user interface software components that are managed and displayed in a web portal. Portlets produce fragments of markup code that are aggregated into a portal. Typically, a portal page is displayed as a collection of non-overlapping portlet windows, where each portlet window displays a portlet. Hence a portlet (or collection of portlets) resembles a web-based application that is hosted in a portal. Some examples of portlet applications are email, weather reports, discussion forums, and news.

Responsive web design (RWD) is a web design approach aimed at crafting web sites to provide an optimal viewing experience—easy reading and navigation with a minimum of resizing, panning, and scrolling—across a wide range of computing devices (from mobile phones to desktop computer monitors). A web site designed with RWD adapts the layout to the viewing environment by using fluid, proportion-based grids, flexible images, and media queries. A media query is a Cascading Style Sheet 3 (CSS3) module allowing content rendering to adapt to conditions such as screen resolution (e.g. smartphone screen vs. computer screen).

### SUMMARY

Embodiments of the present invention disclose a method for distributing web components for display. The method may include one or more computer processors receiving a request for a plurality of web components from a user on a first computing device. The one or more computer processors fetch the plurality of web components. The one or more computer processors determine whether the first computing device and one or more additional computing devices are registered in association with the user. Responsive to determining the first computing device and one or more additional computing devices are registered in association with the user, the one or more computer processors identify preferred device capabilities for at least one of the plurality of web components. The one or more computer processors identify a best match of the preferred device capabilities for the at least one of the plurality of web components to one or more device capabilities of a target computing device, the target computing device being the first computing device or the one or more additional computing devices. The one or more computer processors distribute the at least one of the plurality of web components to the first computing device or the one or more additional computing devices, based, at least in part, on the identified best match.

### BRIEF DESCRIPTION OF THE SEVERAL VIEWS OF THE DRAWINGS

FIG. 1 is a functional block diagram illustrating a distributed data processing environment, in accordance with an embodiment of the present invention;

FIG. 2 illustrates an example of a cross device portal program executing on a server computer within the distributed data processing environment of FIG. 1, in accordance with an embodiment of the present invention.

FIG. 3 is a flowchart depicting operational steps of the cross device portal program, on the server computer within the distributed data processing environment of FIG. 1, for distributing web content for display across multiple devices, in accordance with an embodiment of the present invention; and

FIG. 4 depicts a block diagram of components of the server computer executing the cross device portal program within the distributed data processing environment of FIG. 1, in accordance with an embodiment of the present invention.

### DETAILED DESCRIPTION

An increasingly diverse range of mobile devices, personal computers, intelligent home and office appliances, as well as shared public devices have reached a mass market. Each device is specialized for one or more usage scenarios, and the devices can differ significantly in computing, networking, and I/O capabilities. In addition, the number of computing devices per user is quickly increasing. Consumers use many systems, gadgets, and computers both sequentially and in parallel. Coordinating applications across multiple devices may be difficult for a user.

Embodiments of the present invention recognize that efficiency may be gained by providing a single, coherent user interface across a nonhomogeneous set of different types of devices. Implementation of an embodiment may include decomposing a web page into individual components and distributing the various components to multiple devices based on user preference and the capability of each device. Implementation of embodiments of the invention may take a variety of forms, and exemplary implementation details are discussed subsequently with reference to the Figures.

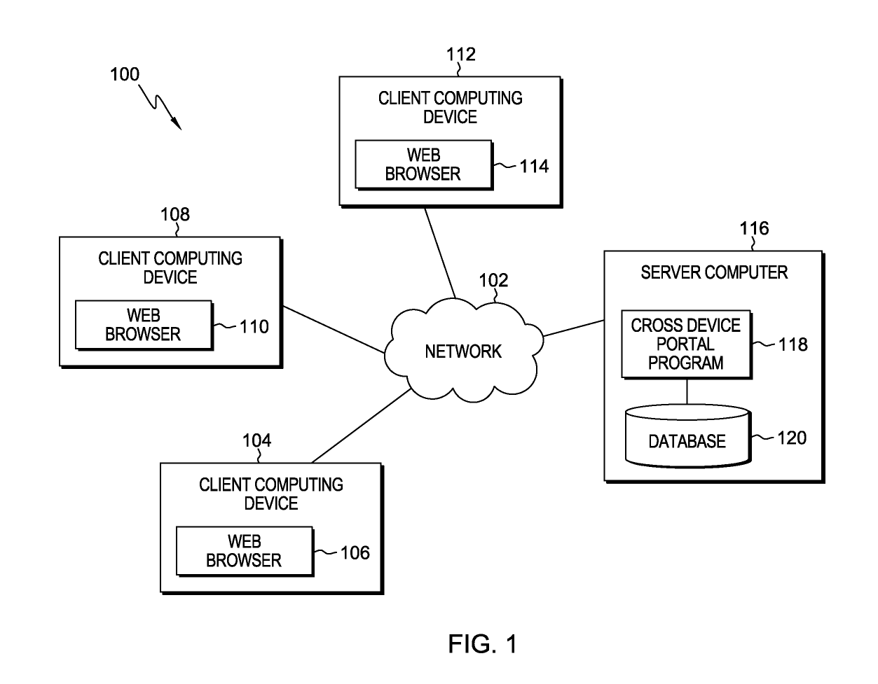

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes client computing devices 104, 108, and 112 and server computer 116, all interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information.

Client computing devices 104, 108, and 112 can each be a desktop computer, a laptop computer, a tablet computer, a specialized computer server, a smartphone, or any programmable electronic device capable of communicating with server computer 116 via network 102 and with various components and devices within distributed data processing environment 100. Client computing devices 104, 108, and 112 can each be a wearable computer. Wearable computers are miniature electronic devices that may be worn by the bearer under, with or on top of clothing, as well as in glasses, hats, or other accessories. Wearable computers are especially useful for applications that require more complex computational support than just hardware coded logics. In general, client computing devices 104, 108, and 112 each represents any programmable electronic device or combination of programmable electronic devices capable of executing machine readable program instructions and communicating with other computing devices via a network, such as network 102. Client computing devices 104, 108, and 112 include, respectively, web browsers 106, 110, and 114.

Web browsers 106, 110, and 114 reside, respectively, on client computing devices 104, 108, and 112. A web browser is a software application for retrieving, presenting, and traversing information resources on the World Wide Web. Although web browsers are primarily intended to use the World Wide Web, they can also be used to access information provided by web servers in private networks, including intranets, or files in file systems. A web browser may use a web user interface (WUI) to display text, documents, web browser windows, user options, application interfaces, and instructions for operation.

Server computer 116 can be a management server, a web server, or any other electronic device or computing system capable of receiving and sending data. In other embodiments, server computer 116 can represent a server computing system utilizing multiple computers as a server system, such as in a cloud computing environment. In another embodiment, server computer 116 can be a laptop computer, a tablet computer, a netbook computer, a personal computer (PC), a desktop computer, a personal digital assistant (PDA), a smartphone, or any programmable electronic device capable of communicating with client computing devices 104, 108, and 112 via network 102. In another embodiment, server computer 116 represents a computing system utilizing clustered computers and components to act as a single pool of seamless resources. Server computer 116 includes cross device portal program 118 and database 120. In an exemplary embodiment, where server computer 116 is a web server, server computer 116 includes a plurality of web pages with application components to distribute to client computing devices based on the preferred capabilities of the devices. In another embodiment, a web server resides separately within distributed data processing environment 100.

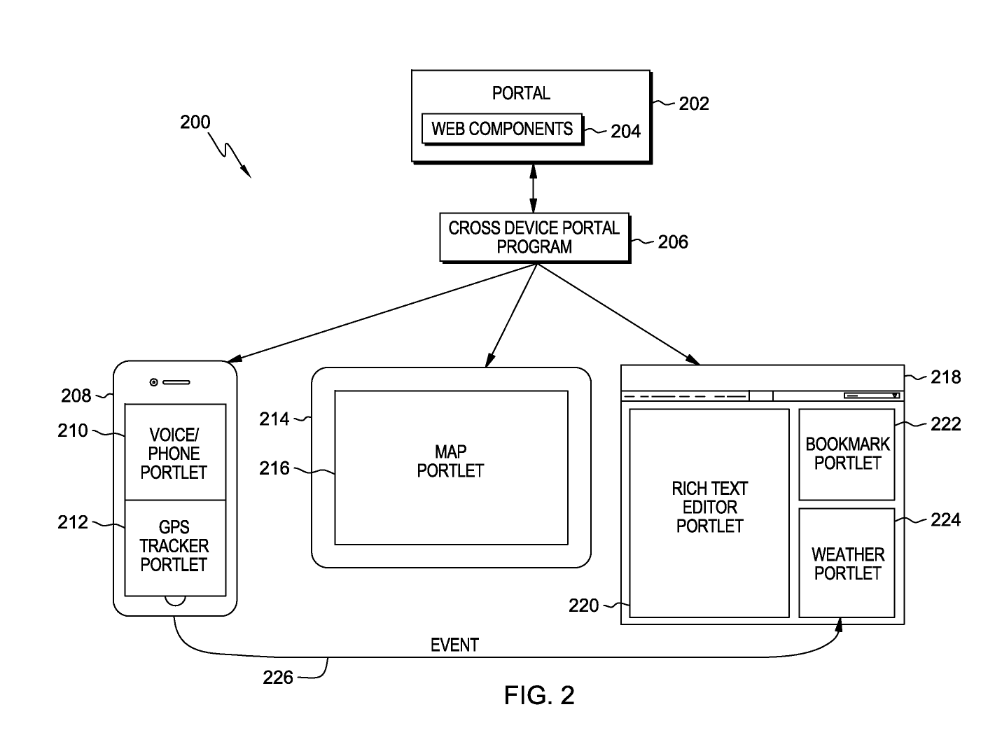

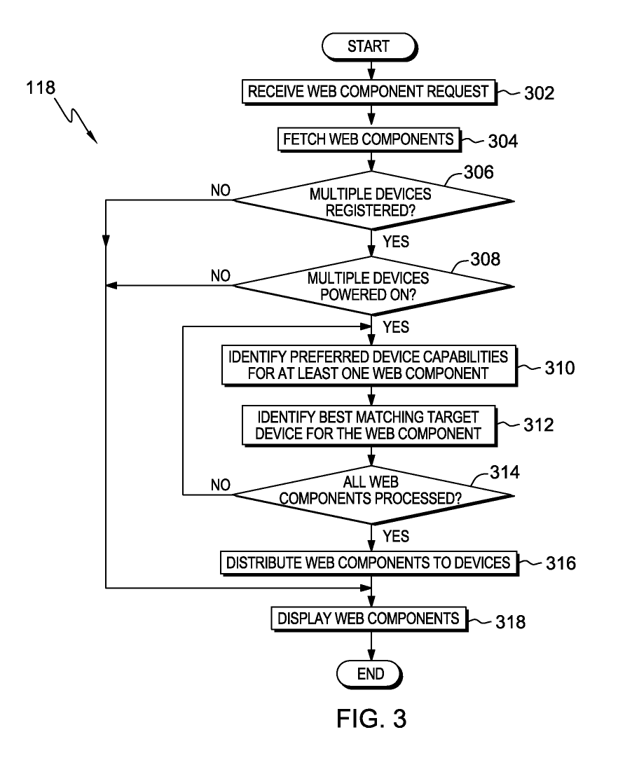

Cross device portal program 118 uses internet portal technology to establish a common session across multiple devices. An internet portal is a technology that aggregates data and markup from various, non-homogeneous sources and provides a consistent, user-specific view. Aggregation of building bricks, for example, portlets, is done based on the user's role and current context, as well as other criteria. The result of the aggregation is a composite page which the portal delivers to the user's web browser, for example, web browser 106, 110, or 114. Cross device portal program 118 receives a request for web components from a user and fetches the web components. Web components may be, for example, a web page, an application, or a portlet. Cross device portal program 118 determines whether the user has multiple devices registered in database 120. If the user has multiple registered devices, then cross device portal program 118 determines whether one or more of the user's registered devices, in addition to the device on which the user made an initial request, is powered on. If one or more additional devices are powered on, then cross device portal program 118 decomposes the requested aggregate web page into portlets and distributes the portlet web content to the multiple devices based on the capability of each device to optimize the user's interaction with each portlet. Cross device portal program 118 is depicted and described in further detail with respect to FIG. 2 and FIG. 3.

Database 120 resides on server computer 116. In another embodiment, database 120 can reside elsewhere in the environment. A database is an organized collection of data. Database 120 can be implemented with any type of storage device capable of storing data that can be accessed and utilized by client computing devices 104, 108, and 112 and server computer 116, such as a database server, a hard disk drive, or a flash memory. In other embodiments, database 120 can represent multiple storage devices within distributed data processing environment 100 or within server computer 116. Database 120 stores a registry of users of cross device portal program 118 and a registry of one or more devices belonging to the registered users. In an embodiment, in order to utilize cross device portal program 118, a user initially registers a username and any devices the user may want cross device portal program 118 to access. Database 120 also stores the specifications and capabilities of each of the registered devices. In one embodiment, a user manually inputs the specifications and capabilities of each of the devices to database 120. In another embodiment, the user may provide links to the manufacturers' websites from which the specifications and capabilities of the devices can be downloaded to database 120. In an exemplary embodiment where server computer 116 is a web server, database 120 stores the definition of web pages and application components, as well as the preferred runtime capabilities of the web pages and application components.

FIG. 2 illustrates an example of cross device portal program 118, represented by cross device portal program 206, executing on a server computer, such as server computer 116 within distributed data processing environment 100 of FIG. 1, in accordance with an embodiment of the present invention.

In diagram 200, cross device portal program 118, as described with respect to FIG. 1, is represented by cross device portal program 206. Diagram 200 includes portal 202. Portal 202 is a web page composed of web components 204. Web components 204 may include a plurality of web component types, for example, information, such as a weather forecast, and applications such as a stock ticker or a travel expense application. Cross device portal program 206 receives a request for web components 204 from a user. Cross device portal program 206 fetches the requested web components 204 from portal 202. Cross device portal program 206 determines that the user currently has three client computing devices powered on. Smartphone 208 represents client computing device 104, as depicted in FIG. 1. Tablet 214 represents client computing device 108, as depicted in FIG. 1. Laptop 218 represents client computing device 112, as depicted in FIG. 1.

Cross device portal program 206 analyzes web components 204 to determine for which device capabilities each of the plurality of web components 204 is best suited. Cross device portal program 206 determines that voice/phone portlet 210 of web components 204 is best suited for a device with a microphone. Cross device portal program 206 determines that GPS tracker portlet 212 of web components 204 is best suited for a device with a GPS sensor. Cross device portal program 206 determines that map portlet 214 of web components 204 is best suited for a device with a touch screen. Cross device portal program 206 determines that rich text editor portlet 220 of web components 204 is best suited for a device connected to a large keyboard. Cross device portal program 206 determines that both bookmark portlet 222 and weather portlet 224 of web components 204 are best suited to a device that includes a large enough display to show both portlets at once.

Based on the determinations of preferred device capabilities stored in database 120 of FIG. 1, cross device portal program 206 distributes voice/phone portlet 210 and GPS tracker portlet 212 to smartphone 208. Cross device portal program 206 also distributes map portlet 216 to tablet 214. In addition, cross device portal program 206 distributes rich text editor portlet 220, bookmark portlet 222, and weather portlet 224 to laptop 218. Although the various portlets are distributed across three devices, the portlets share a common portal session and can participate in coordination mechanisms. The arrow denoted as event 226 represents a coordination mechanism occurring between smartphone 208 and laptop 218. For example, activation of GPS tracker portlet 212 in smartphone 208 may send a request to weather portlet 224 in laptop 218 to display the current weather radar in the vicinity of the location of smartphone 208.

FIG. 3 is a flowchart depicting operational steps of cross device portal program 118, on server computer 116 within distributed data processing environment 100 of FIG. 1, for distributing web content for display across multiple devices, in accordance with an embodiment of the present invention.

Cross device portal program 118 receives web component request (step 302). When a user of client computing devices 104, 108, or 112 requests one or more web components via web browser 106, 110, or 114, cross device portal program 118 receives the request. A web component may be a simple article or an application. A web page is comprised of one or more web components. In general, a request for web components can be a request for web content on a particular web page.

Cross device portal program 118 fetches web components (step 304). Per the received request, cross device portal program 118 fetches the requested web components. As discussed earlier with respect to FIG. 1, an internet portal aggregates the web components, and cross device portal program 118 fetches the requested web components using internet portal technology.

Cross device portal program 118 determines whether multiple devices are registered by the user (decision block 306). Cross device portal program 118 accesses database 120 and analyzes the list of registered users and the associated registered devices to determine if the user is registered and has registered the device from which the user made the request and one or more additional devices. If cross device portal program 118 determines that multiple devices are not registered by the user (“no” branch, decision block 306), then cross device portal program 118 displays the requested web components (step 318). If the user has no registered devices or only one registered device, then cross device portal program 118 displays the requested web components in the web browser of the device from which the user made the request. For example, if the user has registered only client computing device 104, then cross device portal program 118 displays the requested web components in web browser 106. In one embodiment, if cross device portal program 118 determines the user is registered but the device the user made the request from is not registered, cross device portal program 118 requests the user registers the active device.

If cross device portal program 118 determines multiple devices are registered by the user (“yes” branch, decision block 306), then cross device portal program 118 determines whether multiple devices are powered on (decision block 308). A user may have registered more than one device, for example, client computing devices 104, 108, and 112. Cross device portal program 118 determines whether more than one of the multiple registered devices is powered on. If cross device portal program 118 determines that multiple devices are not powered on (“no” branch, decision block 308), then cross device portal program 118 displays the requested web components (step 318). If only one of the user's registered devices is powered on, then cross device portal program 118 displays the requested web components in the web browser of the powered device. For example, client computing devices 104, 108, and 112 are registered to the user, but only client computing device 104 is powered on, therefore cross device portal program 118 displays the requested web components in web browser 106.

If cross device portal program 118 determines that multiple devices are powered on (“yes” branch, decision block 308), then cross device portal program 118 identifies the preferred device capabilities for at least one web component (step 310). Cross device portal program 118 analyzes the media queries included in the markup for each web component to identify preferred device capabilities. For example, a web component, or a portlet, that uses a significant amount of keyboard input is best suited for a device with a large keyboard. In another example, a web component that displays map information is best suited for a device with a large color display.

Cross device portal program 118 identifies the best matching target device for the web component (step 312). Responsive to identifying the preferred device capabilities for a web component, cross device portal program 118 identifies which of the user's multiple devices is best suited for the component or portlet. Cross device portal program 118 analyzes the device capabilities stored in database 120 and matches the device capabilities to the web component preferences. For example, a web component is best suited for a device with a camera, and client computing device 104 is a smartphone, client computing device 108 is a laptop, and client computing device 112 is a smartwatch. Cross device portal program 118 determines that client computing device 104 is best suited for the web component because client computing device 104 has an integrated camera and client computing devices 108 and 112 may not have cameras. In one embodiment, cross device portal program 118 determines which device includes capabilities that meet a pre-defined threshold number of the web component's preferred device capabilities to consider the capabilities a match. In another embodiment, cross device portal program 118 determines whether the preferred device capabilities are preferred or mandatory. If the device capabilities are not mandatory, and cross device portal program 118 does not find a device with an appropriate match of capabilities, then cross device portal program 118 may omit the display of the web component or cross device portal program 118 may display the web component on a default device, such as the device from which the request was made. If the device capabilities are mandatory, and cross device portal program 118 does not find a device with an appropriate match of capabilities, then cross device portal program 118 omits the display of the web component. In a further embodiment, if cross device portal program 118 does not find a device with an appropriate match of capabilities, then cross device portal program 118 may present a list to the user from which the user can choose on which device to display each web component.

Cross device portal program 118 determines whether all web components are processed (decision block 314). Cross device portal program 118 analyzes the preferred capabilities for each web component separately, therefore cross device portal program 118 determines whether all of the web components have been analyzed for a matching target device. In one embodiment, if the user does not want all the components processed, the user can choose which components to process. If all of the web components have not been processed (“no” branch, decision block 314), then cross device portal program 118 returns to step 310 to determine the preferred device capabilities of the next web component.

If all of the web components have been processed (“yes” branch, decision block 314), then cross device portal program 118 distributes the web components to the identified devices (step 316). In one embodiment, after matching the user's registered, powered on devices to the web components' preferred device capabilities, cross device portal program 118 decomposes the aggregate portal page and distributes each web component, or portlet, to the matched device. In another embodiment, cross device portal program 118 presents a list of the matches to the user and allows the user to choose on which device to display each component.

Cross device portal program 118 displays the requested web components (step 318). After cross device portal program 118 distributes the various web components to the devices with capabilities best suited to the component, cross device portal program 118 displays the web components requested by the user in the matched devices. Although cross device portal program 118 displays the components on different devices, the components can interact with each other because each component is a portlet from a common portal. For example, a user can take a picture of a receipt with a camera application on a smartphone, and a travel expense application on a laptop can receive and process the photographed image.

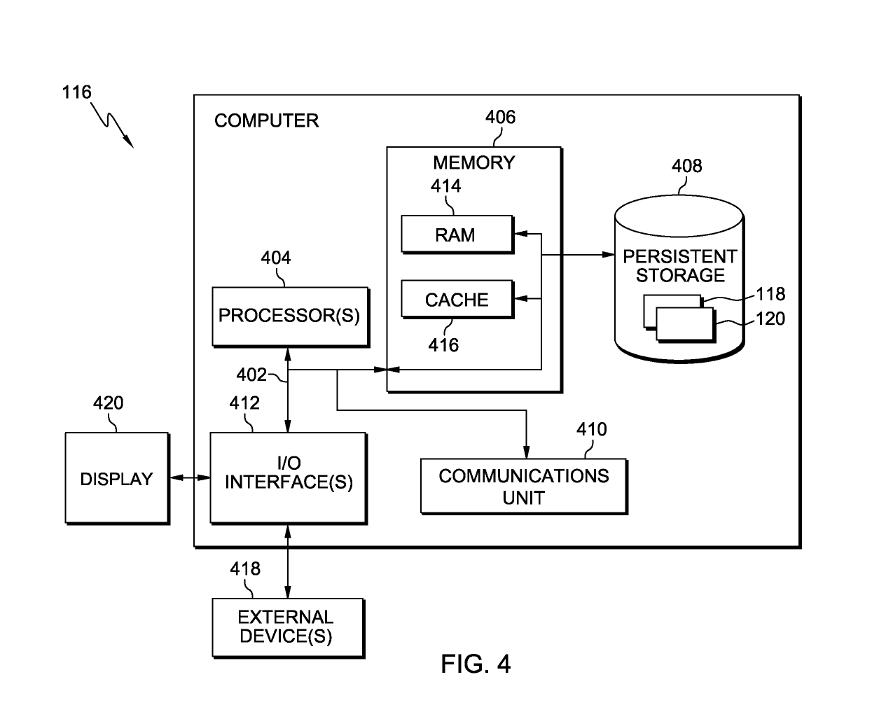

FIG. 4 depicts a block diagram of components of server computer 116 executing cross device portal program 118 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Server computer 116 can include communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media.

Cross device portal program 118 and database 120 are stored in persistent storage 408 for execution and/or access by one or more of the respective computer processor(s) 404 of server computer 116 via one or more memories of memory 406. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 can also be removable. For example, a removable hard drive can be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of client computing devices 104, 108, and 112. In these examples, communications unit 410 includes one or more network interface cards. Communications unit 410 can provide communications through the use of either or both physical and wireless communications links. Cross device portal program 118 and database 120 can be downloaded to persistent storage 408 of server computer 116 through communications unit 410.

I/O interface(s) 412 allows for input and output of data with other devices that can be connected to server computer 116. For example, I/O interface(s) 412 can provide a connection to external device(s) 418 such as a keyboard, a keypad, a touch screen, a microphone, and/or some other suitable input device. External device(s) 418 can also include portable computer readable storage media such as, for example, thumb drives, portable optical or magnetic disks, and memory cards. Software and data used to practice embodiments of the present invention, e.g., cross device portal program 118 and database 120 on server computer 116, can be stored on such portable computer readable storage media and can be loaded onto persistent storage 408 of server computer 116 via I/O interface(s) 412. I/O interface(s) 412 also connect to a display 420.

Display 420 provides a mechanism to display data to a user and can be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for distributing web components for display, the method comprising:
receiving, by one or more computer processors, a request for a plurality of web components from a user on a first computing device;
fetching, by the one or more computer processors, the plurality of web components;
determining, by the one or more computer processors, whether the first computing device and one or more additional computing devices are registered in association with the user;
responsive to determining the first computing device and one or more additional computing devices are registered in association with the user, identifying, by the one or more computer processors, preferred device capabilities for at least one of the plurality of web components;
identifying, by the one or more computer processors, a best match of the preferred device capabilities for the at least one of the plurality of web components to one or more device capabilities of a target computing device, the target computing device being the first computing device or the one or more additional computing devices; and
distributing, by the one or more computer processors, the at least one of the plurality of web components to the first computing device or the one or more additional computing devices, based, at least in part, on the identified best match.

2. The method of claim 1, further comprising, responsive to distributing the at least one of the plurality of web components to the first computing device or the one or more additional computing devices, displaying, by the one or more computer processors, the at least one web component.

3. The method of claim 1, wherein at least one of the plurality of web components include one or more of a web content, a web page, an application, and a portlet.

4. The method of claim 1, wherein determining whether the first computing device and one or more additional computing devices are registered in association with the user further comprises:
determining, by the one or more computer processors, whether the first computing device and the one or more additional computing devices are associated with the user in a database; and
responsive to determining the first computing device and the one or more additional computing devices are associated with the user in the database, determining, by the one or more computer processors, whether one or more device capabilities associated with the first computing device and the one or more additional computing devices are stored in the database.

5. The method of claim 1, wherein fetching the plurality of web components utilizes web portal technology.

6. The method of claim 1, wherein identifying a best match of the preferred device capabilities for the at least one of the plurality of web components to the one or more device capabilities of the target computing device, the target computing device being the first computing device or the one or more additional computing devices, further comprises:
analyzing, by the one or more computer processors, the preferred device capabilities for the at least one of the plurality of web components;
analyzing, by the one or more computer processors, the one or more device capabilities of the first computing device and the one or more additional computing devices; and
determining, by the one or more computer processors, which of the first computing device and the one or more additional computing devices includes at least one device capability that meets a pre-defined threshold number of preferred device capabilities for the at least one of the plurality of web components.

7. The method of claim 1, wherein the one or more device capabilities include computing capabilities, networking capabilities, and I/O capabilities.

8. The method of claim 1, further comprising, determining, by the one or more computer processors, whether one or more of the one or more additional computing devices are powered on.
